(19) United States
(12) Patent Application Publication
(10) Pub. No.: US 2015/0314199 A1
(43) Pub. Date: Nov. 5, 2015

(54) Analytics Enabled By A Database-Driven Game Development System

(71) Applicant: MPH, Inc., San Francisco, CA (US)

(72) Inventors: Adam Cory Chapman, Los Angeles, CA (US); Shaun Michael Rance, Los Angeles, CA (US)

(21) Appl. No.: 14/701,350

(22) Filed: Apr. 30, 2015

Related U.S. Application Data
(60) Provisional application No. 61/987,239, filed on May 1, 2014.
(60) Provisional application No. 61/987,244, filed on May 1, 2014.
(60) Provisional application No. 61/987,253, filed on May 1, 2014.
(60) Provisional application No. 61/987,256, filed on May 1, 2014.
(60) Provisional application No. 61/987,267, filed on May 1, 2014.

(51) Int. Cl. A63F 13/63; A63F 13/73

(52) U.S. Cl. CPC A63F 13/63; A63F 13/73

(57) ABSTRACT

A database-driven collaborative game development system provides detailed tracking of changes made to an electronic game by multiple remote developers. The system aggregates the data on a server and then presents analytical data in a manner useful for tracking managing development of the electronic game. The data is tracked objectively and may be displayed in real time, allowing managers to see exactly how their game development team or individual employees are performing. This data may be also used to objectively report team or individual productivity or to subjectively analyze and optimize productivity.

### CROSS REFERENCE TO RELATED APPLICATIONS

This application claims the benefit of U.S. Provisional Application No. 61/987,239 entitled “Authoring/Development Analytics Enabled by Database-Driven Rich Media Authoring Tool,” to Adam Chapman, et al., filed on May 1, 2014, U.S. Provisional Application No. 61/987,244 entitled “Integrated and Automated Runtime Analytics Enabled by Database-Driven Rich Media Authoring Tool” to Adam Chapman, et al., filed on May 1, 2014, U.S. Provisional Application No. 61/987,253 entitled “Integrated Game Analytics” to Shaun Rance, et al., filed on May 1, 2014, U.S. Provisional Application No. 61/987,256 entitled “Play Trace Issue Logging” to Shaun Rance, et al., filed on May 1, 2014, U.S. Provisional Application No. 61/987,267 entitled “Metrics Visualization” to Ammon R. Lauritzen, et al., filed on May 1, 2014. The contents of all of the above are incorporated by reference herein.

### BACKGROUND

1. Field of Art

The disclosure generally relates to a collaborative development system for creating electronic games.

2. Description of the Related Art

Games are created by teams of fulltime and contract employees, often working in disparate parts of the world. Tracking, reporting, and optimizing team performance is a full time job requiring a lot of guess work and coordination. Gathering information and metrics on project development has been, until now, a time-delayed, high touch soft science requiring subjective information gathering and data input. Others have tried to track this data by counting check-ins to repository systems and then entering them into a different tracking system for reports and visualization. At best, this is intermittent, extremely time consuming and error-prone. At worst this process involves subjective interpretation and guessing.

### BRIEF DESCRIPTION OF DRAWINGS

The disclosed embodiments have advantages and features which will be more readily apparent from the detailed description, the appended claims, and the accompanying figures (or drawings). A brief introduction of the figures is below.

FIG. 1 is a system diagram illustrating an embodiment of a collaborative game development environment.

FIG. 2 is a flowchart illustrating an example embodiment of a process for managing changes to a game by different remote developers in a collaborative game development environment.

FIG. 3 is a flowchart illustrating an example embodiment of a process for generating analytical data relating to game development in a collaborative game development environment.

FIG. 4 illustrates an example of a first user interface screen for viewing analytical data relating to game development in a collaborative game development environment.

FIG. 5 illustrates an example of a second user interface screen for viewing analytical data relating to game development in a collaborative game development environment.

FIG. 6 illustrates an example of a third user interface screen for viewing analytical data relating to game development in a collaborative game development environment.

FIG. 7 illustrates one embodiment of components of an example machine able to read instructions from a non-transitory machine-readable medium and execute them in a processor (or controller).

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Configuration Overview

A database-driven collaborative game development environment and system provides detailed tracking of changes made to an electronic game by multiple remote developers. Changes are tracked based on, for example, the developer making the change, the time of the change, and type of change. The system aggregates the data on a server and then presents analytical data in a manner useful for tracking managing development of the electronic game. The data is tracked objectively and may be displayed in real time, allowing managers to see exactly how their game development team or individual employees are performing. This data may be also used to objectively report team, individual, or objective productivity or to subjectively analyze and optimize productivity.

A first embodiment of a disclosed system, method and computer readable storage medium includes managing changes to digital gaming assets in a collaborative electronic game development environment including multiple remote developer clients. An indication of a change to a digital gaming asset made by a local developer client device executing a game editor is stored to a local database. A computing device determines if a duplicate of the digital gaming asset exists in the local database. Responsive to determining that the duplicate of the digital gaming asset does not exist in the local database, the computing device determines if a duplicate of the digital gaming asset exists in a master database at a master server, the master database server at a central location remote from the local database and the local developer client. Responsive to determining that the duplicate of the digital gaming asset exists in at least one of the local database and the master database, the change is logged to the digital gaming asset in a local database change log. Responsive to determining that that the duplicate of the digital gaming asset does not exist in either the local database or the master database, the digital gaming asset is imported to the local database in a compressed form and importation of the digital gaming asset in the local database change log is logged. The local database is synchronized to the master database to update the master database based on the local database change log. The local database is also synchronized from the master database to update the local database with changes in the master database corresponding to changes made at other remote developer clients. At a local developer client, a report characterizing game development status is requested based on contents of the master database. The report is provided to the local developer client.

A second embodiment, of a disclosed system, method and computer readable storage medium includes generating analytical data representing changes in a collaborative electronic game development environment including multiple remote developers. Indications of changes made to digital assets in a digital game are received from a plurality of different local databases, where each of the changes are provided from a developer client devices executing a game editor. A master database is updated with the changes made at each of the plurality of local database servers. A master change log is generated logging changes to the master database. The changes are aggregated by assigning metadata tags to group a plurality of related changes. A report is generated characterizing the changes based on the metadata tags. The report is then provided to a requesting local developer client.

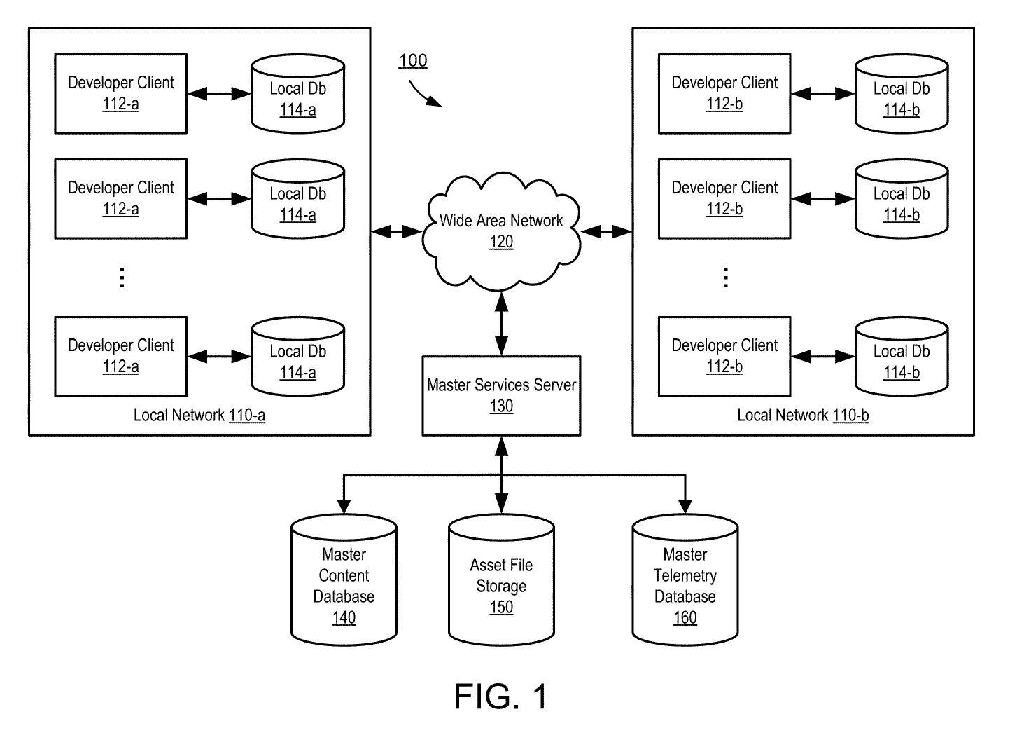

FIG. 1 illustrates an embodiment of a collaborative game development system 100 for developing digital games for platforms such as, for example, gaming consoles, PCs, tablets, and mobile devices. The collaborative game development system 100 enables multiple game developers, potentially working in different remote locations, to collaboratively develop a game. Furthermore, the collaborative game development environment enables managers to effectively manage, track, and generate reports detailing progress of the game under development.

The collaborative game development system 100 comprises a first local network 110-a connecting a first plurality of developer clients 112-a at a first location and a second local network 110-b connecting a second plurality of developer clients 112-b at a second location. Each of the developer clients 112 is coupled with a local database 114. The local database 114 may be stored, for example, in a storage device directly attached to a developer client 112 or elsewhere on the local network 110. In some embodiments, one or more of the local databases 114 may be shared among two or more developer clients 112 on the same local network 110. In one embodiment, the local databases 114 use a no-SQL database that uses a concept of documents rather than rows and tables. The first local network 110-a and the second local network 110-b are each coupled to a wide area network 120 (such as the Internet) to connect the first local network 110-a and the second local network 110-b to a master services server 130. The master services server 130 provides access to and controls a master content database 140, an asset file storage 150, and a master telemetry database 160 that are each accessible to each of the developer clients 112. In alternative embodiments, the master services server 130, master content database 140, asset file storage 150, and master telemetry database 160 are not necessarily remote from the local network 110-a or 110-b. In an embodiment, all network traffic for collaboration, asset sharing, and development telemetry pass through the master services server 130. The master services server 130 may provide services such as, for example, authentication, database storage, file storage, telemetry data storage, and collaboration tools.

The asset file storage 150 stores binary data for digital assets used in the game under development. As used herein, an “asset” comprises a digital file or object representing game data. Examples of assets include scripts, meshes, animations, textures, shaders, audio files, etc. The asset file storage 150 additionally stores revisions to assets as they are being updated during development of the game.

The master content database 140 stores metadata associated with the game including notes about implementation, usage, materials, measurements, etc. The information dictates where, how, and when objects appear in the game, and contains all world, level, execution, and packaging data. The master content database 140 furthermore stores a history of all revisions made to the game under development and project data including changes to executable code, metadata, and other components for the game under development. In one embodiment, the master content database 140 stores associations between digital assets and various metadata. The master content database 140 may indicate, for example, how certain assets are being applied in the game under development (e.g., what textures are applied to a given object, what level and location the object appears, characteristics associated with the asset, etc.). In one embodiment, the master database 130 use a no-SQL database that uses a concept of documents rather than rows and tables.

The master telemetry database 160 stores all telemetry data from development. The telemetry data may include, for example, a number of assets submitted by an individual developer, time spent developing assets, changes made to the asset (placement, scale, physics, etc.), notes added by a developer, assets imported, etc. The tracked telemetry thus indicates what actions were performed by different developers during development of the game, how long the actions took, when the actions were taken, and who took the actions. Such tracking enables a manager to access information describing all changes made to the game by various developers throughout all stages of development. The master telemetry database 160 also stores gameplay data such as player data, information about how, where, and when the game is played, level completion information, device information, how the players played, what gameplay decisions were made, etc.

The collaborative game development system 100 beneficially facilitates real-time collaborative game development and enables game developers to track every change made to the game during development, such as, for example, importing assets, changing positions of assets, writing scripts, etc.). In order to ensure that changes made to an asset or newly imported assets from one developer client 112 are propagated to other developer clients 112, the developer client 112 making the change or import checks whether the asset already exists and modifies the corresponding local database 110 to log the change or import. The developer client 112 creates and stores a log detailing the differences made (delta) by that developer client 112 from the last state of the project. Each local project database 110 is selectively synced with the master content database 140 and so that changes made at one developer client 112 are propagated to the master content database 140, which is in turn synched to other local databases 114 for other clients 112.

A benefit of the distributed architecture of FIG. 1 is that the local databases 114 enables the developer clients 112 to work offline and distribute the load. Synchronizations to the master database 140 can be done when the master database 140 is available or when otherwise convenient. The provided architecture supports a branching structure, so that normal operation (one or a few developers working in the same branch) do not cause contention with others. Merging may be done when the project directors determine it is tune rather than constantly. The architecture of Hal also enables resolution of resolve granular pieces of assets to both avoid merge conflicts and allow developers to work together without conflicts.

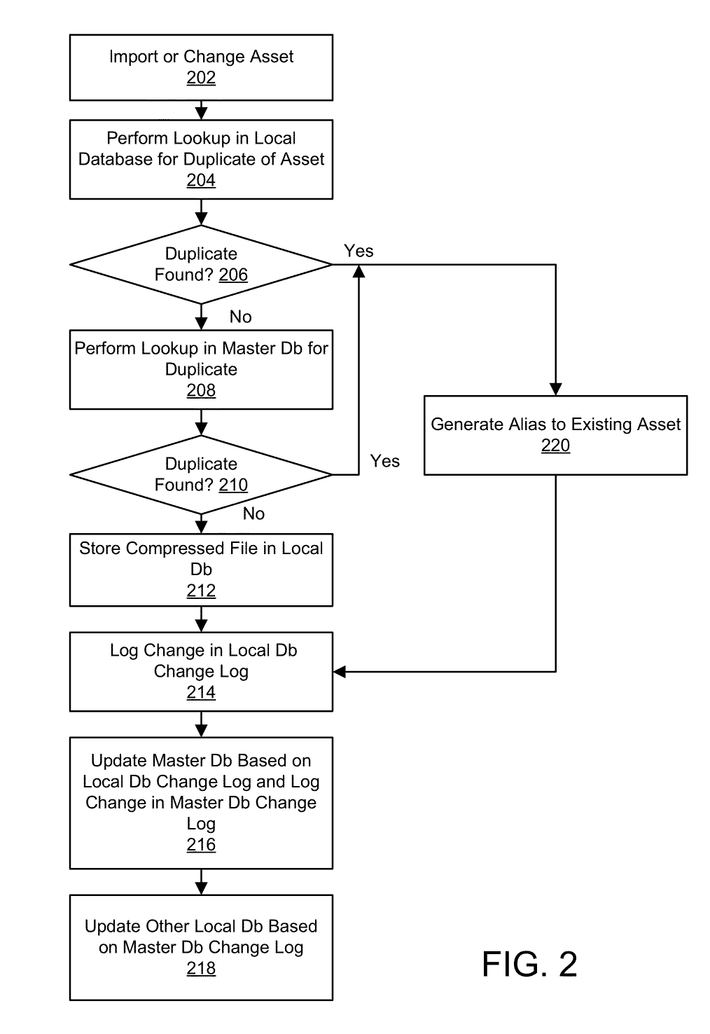

FIG. 2 is a flowchart illustrating an embodiment of a process for managing new assets created in a collaborative electronic game development system 100 that includes multiple remote developers. A developer client 112 imports or changes 202 an asset in a game editor application. New assets (except for scripts) may be created and imported using an external digital content creation (DCC) tool and imported into an editor on the developer client 112. Examples of new assets that may be created include, for example, an audio file, a polygon mesh (e.g., fbx format), an image file, a texture, etc. Changes to assets may include, for example, changes to asset usage, placement, association with other assets, placement, scale, rotation, level of detail (LoD), or attachment of scripts, materials, lighting, effects, physics properties, analytics, etc. to the asset.

The developer client 112 performs 204 a lookup in its corresponding local database 114 to see if the asset being imported already exists in the local database 114. If the developer client 112 determines 206 that the asset already exists in its local database 114, the developer client 112 stores a flag indicating that the asset already exists and generates 220 an alias to the existing asset by creating a new entry in the local database 114 storing a reference or pointer (e.g., asset²) to the originally imported asset (e.g., asset¹). The process then proceeds to step 214 described below. In one embodiment, step 220 may be performed only when new assets are imported but not when changes are made to existing assets. Aliases to a single asset significantly save on compression and storage needs. Instead of duplicating an asset each time it is used in the game, a reference to the original asset is instead created and any changes are stored together with the reference. An advantage to using aliases is that a developer client 112 can download the original asset only once. This saves significant time and bandwidth for distributed teams that work on disparate scenes that may have different instantiations of the original asset. For example, if one developer is working on a scene that has a table in it and is also working on a different unrelated scene that has a table in it, the developer only downloads the table asset one time. The different instantiations of the assets may be tracked to make global or local changes, track usage, predict conflicts, help predict cook time and file size, etc.

If the developer client 112 determines 206 that a duplicate exists in its local database 114, the developer client 112 stores a flag indicating that the asset is possibly a unique new asset and then performs 208 a lookup in the master content database 140 to determine if a duplicate exists there. In one embodiment, if the developer client 112 is not currently connected to the master content database 140 during this step (e.g., because the developer client 112 is offline and not connected to the wide area network 120 or because the master services server 130 is down), the developer client 112 temporarily treats the asset as unique. The developer client 112 may then perform this lookup at a later time when connected to the master content database 140. In one embodiment, the developer client 112 periodically synchronizes its local database 114 with the master content database 140 and the lookup in step 208 occurs during synchronization rather than every time a new asset is created.

If the developer client 112 determines 210 that the asset already exists in the master content database 140, the developer client 112 generates 220 an alias to the existing asset 220 by creating an entry in its local database 112 as described above. If the developer client 112 determines 210 that no duplicate is found and the asset is unique, the developer client 112 stores 212 a compressed file representing the asset in the local database 114. The developer client 112 logs 214 a change in a change log associated with the local database 114 indicating the creation of either the new asset, the creation of an alias of an existing asset, or a change to an existing asset. In one embodiment, the change log includes telemetry data indicating, for example, what the change was, which developer made the change, and when the change occurred.

The master services server 130 updates 216 the master database based on the local database change log and logs the changes to the master content database 140 in a master database change log. For example in one embodiment, compressed changes, the change log, and files representing the new asset are transferred to the master services server 130 for comparison and storage. In one embodiment, this synchronization occurs periodically and may be initiated by either a developer client 112 or the master services server 130. The synchronization may be initiated automatically, manually, or using a REST-based methodology.

The master services server 130 sends 218 updates to other local databases 114 in the collaborative game development system 100 based on changes in the master database change log. This synchronization may also occur periodically and may be initiated by either the individual developer clients 112 or the master services server 130. The synchronization may be initiated automatically, manually, or using a Representational State Transfer (REST)-based methodology.

Using the process above, all changes or imports of assets made by a developer in the collaborative game development environment are tracked in a change log and synchronized to the master content database 140. As a result, the master content database 140 maintains a record of all changes made during the development process. This information can be used to generate useful reports describing various analytical data pertaining to game development.

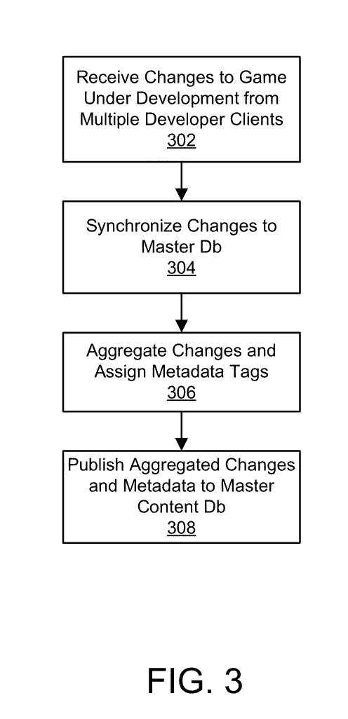

FIG. 3 illustrates an embodiment of a process for generating analytical data pertaining to development of a game in a collaborative gaming environment. In this process, changes made during game development are aggregated from the change log and parsed into a user-readable format. The analytical data can then be presented in a filterable manner.

Particularly, in the process of FIG. 3, a plurality of different developer clients 112 make changes to the game under development and these changes are received 302 at the master services server 130. These changes may include, for example, importing an asset, creating a new script, modifying an existing asset, changes to the asset usage, placement, association, scale, rotation, level of detail, or attachment of scripts, materials, lighting, effects, physics properties, analytics, etc. to the asset. The master services server 130 synchronizes 304 the received changes to the master content database 140 as described in the process of FIG. 2 above. Once the master content database 140 is synchronized to all of the local databases 110, the master content database 140 will store all modifications occurring during development and store these changes in a master log file.

The master services server 130 aggregates 306 change entries (with each entry representing a change indicated in the log file) and automatically assigns metadata tags that enables the changes stored to the master content database to be later sorted and/or filtered. The aggregation may include identifying similar types of changes and generating a single tag describing multiple changes of the same type. For example, multiple changes to an asset in placement, scale, rotation changes are aggregated and may be tagged simply as “Modified Object.” In another example, multiple instances of changes to a given script may be tagged as “Modified Script.” In yet another example, modification of multiple (e.g., N) different assets may be tagged as “Modified N Assets.” In one embodiment, each change logged in the master content database 140 is assigned a unique reference that functions as a link to the change entry so another user may quickly and easily see what the change was and the environment/context in which the change was made.

The aggregated change entries are published 308 (e.g., in a REST manner) to the master content database 140. The master content database 140 can be searched to provide a realtime, sortable, view on the productivity of individual developers and the team and project as a whole.

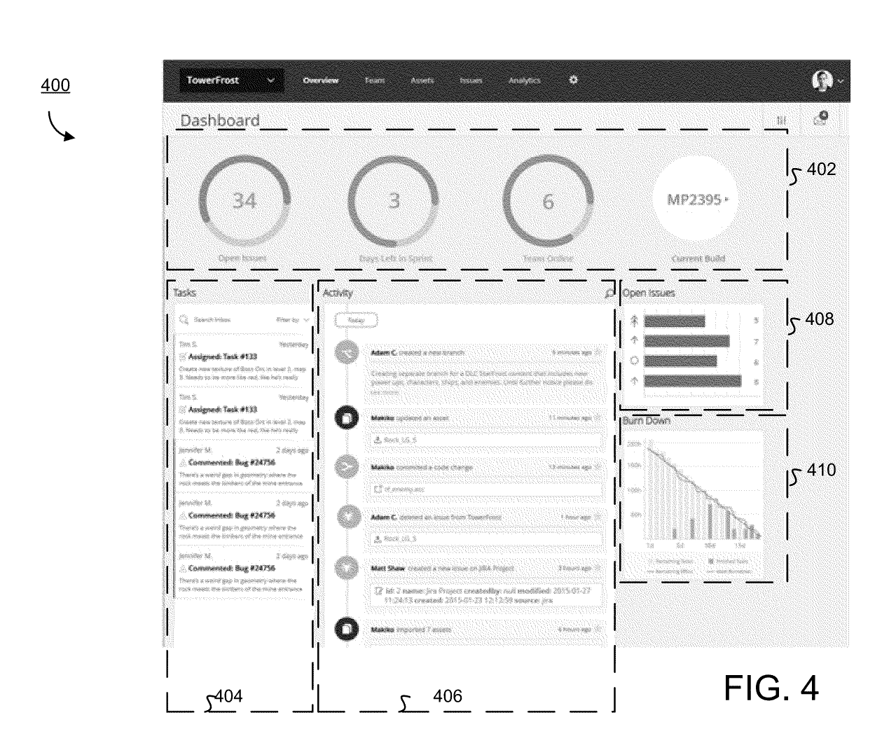

FIGS. 4-6 illustrates example embodiments of user interfaces for viewing analytical data. FIG. 4 is an example of a user interface 400 that provides a dashboard view illustrating a project-wide synopsis of the development status of a game. Area 402 of the user interface 400 provides a high-level overview of pertinent features or sets of features/tasks related to development. Represented here are Open Issues, Days Left in Sprint, Number of team Member Currently Working, and Current Build Version. These items in area 402 are user configurable and may be customized to represent different parameters for different users. For example, the illustrated view is configured for a producer focused on developer productivity. Another user of the collaborative game development system 100 may be concerned with the automated reporting of in-market analytics or gameplay analytics and may therefore configure the area 402 of the user interface to have different high level displays such as average revenue per unit (ARPU), average engagement time, number of active players, etc. Examples of automated reporting of analytics are below

Area 404 of the user interface 400 provides a dashboard snapshot of tasks assigned to different developers. This is a small-scale view of the full task tracking system that enables a user to see information such as task title, owner, last date changed, time since the issue was created, and various other metadata such as task type, team assigned, priority, etc. This view is intended to provide a quick glance. Basic filtering and search is available from this view. If a user seeks to gain more insight on a task listed here, the user may select it and the detailed view is opened in a new/refreshed window.

Area 406 of the user interface 400 provides a snapshot of recent project activities in timeline feed format. This is a small-scale view of the full project activity feed. This view allows a user to see attributes such as activity type, author, time, pertinent information related to a task (e.g. “Moved 5 Objects”), link to the object (as appropriate) and various other metadata such as task type, team assigned, priority, etc. This view is intended to provide a quick glance. Basic filtering and search is available from this view. If a user seeks to gain more insight on an activity, team member or activity type listed here, the user may select the relevant attribute and the detailed view is opened in a new/refreshed window. Area 408 of the user interface 400 provides high level graphic representation of the breakdown (by importance) of open tasks. These items are user configurable and may represent different parameters for different users. Area 410 of the user interface 400 provides a high level graphic representation of a burn down chart on current development. The items represented in the chart are user configurable.

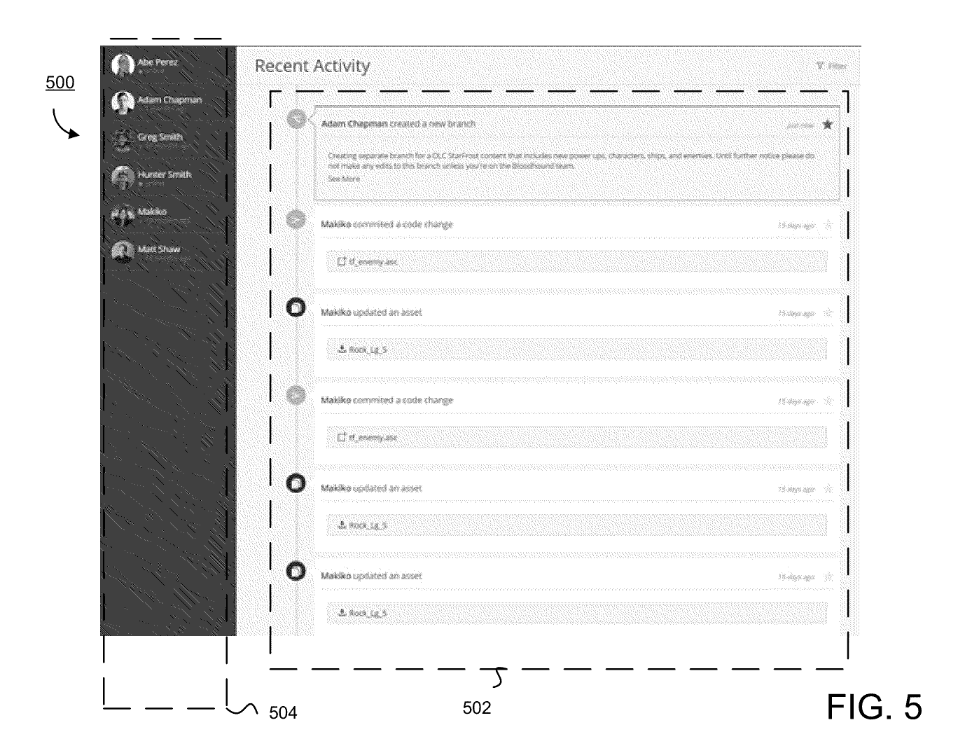

FIG. 5 illustrates a user interface 500 showing a temporal view of all changes made to the game under development in the collaborative game development system 100. Particularly, area 502 of the user interface 500 illustrates a project activity timeline feed that provides a partial view of a full project activity feed representing recent activity for the game under development. The feed allows a user to see, for example, the activity type, author, time, pertinent information overview of the task (e.g. “Moved 5 Objects”), link to the object (as appropriate) and various other metadata such as task type, team assigned, priority, etc. This view represents activities sorted by time. If a user seeks to gain more insight on an activity, team member or activity type listed here, the user can select the relevant attribute and the detailed view is opened in a new/refreshed window. Area 504 of the user interface 500 shows individual team members who are involved with the game development. Selecting a team member in the user interface 500 refreshes the window with detailed activity feed listing activities specifically associated with the selected team member.

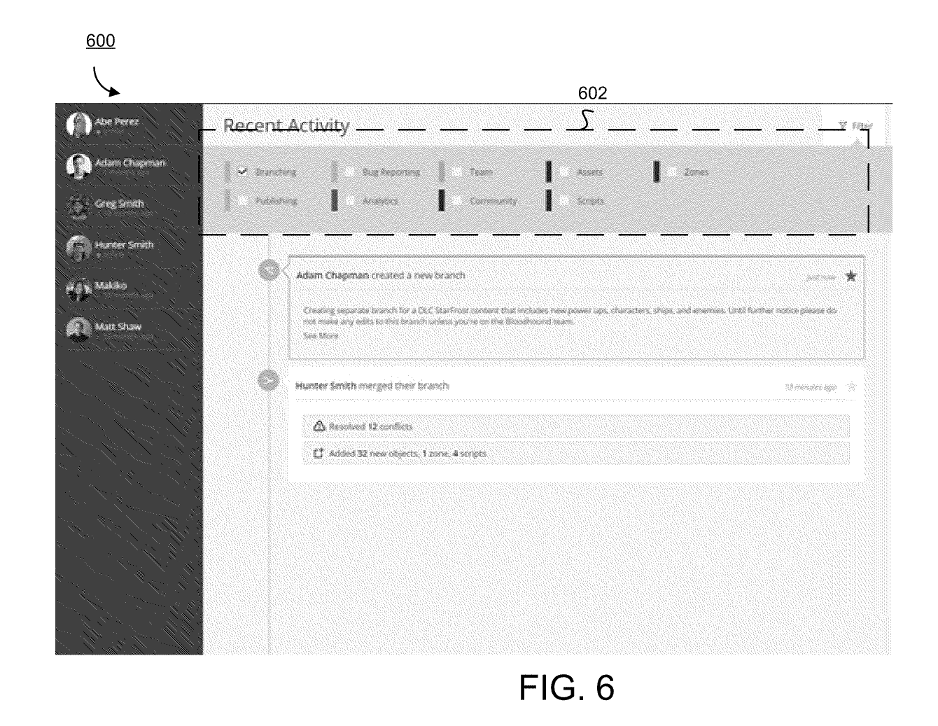

FIG. 6 illustrates a user interface 600 showing a filtered view of changes made to a game in a collaborative game development system 100. Changes may be filtered, for example, by type, discipline, or individual. Area 602 of the user interface 600 provides a filtering interface for project activity feed that allows a user to select which types of activity to display in the activity feed. Selecting certain types of activity changes the activity feed display to only show the selected type sorted by time, with activity type, author, time, pertinent information overview of the task (e.g. “Moved 5 Objects”), link to the object (as appropriate) and various other metadata such as task type, team assigned, priority, etc. represented per activity.

In another embodiment, the database foundation of the collaborative game development environment allows a developer to automatically track and “hot swap” all assets. Every asset is automatically tagged and stored in the master content database 140. When assets are packaged for runtime deployment, they can be auto-tagged to report on display, usage, and engagement. In addition, the analytics tools can automatically track higher level engagement factors; e.g. how long did someone play the game, where did they die, when did they switch out, what kind and specs of device were they using, where did they select items (heatmap of clicks or touch engagement), etc. These analytics may be reported back to the master services server 130 and reported to a developer client 112. The runtime executable draws can push unique content to different developers (enabling multi-variant A/B testing) and updates to existing content; e.g. scripting fixes, asset swapping, etc.

In another embodiment, the collaborative game development system 100 democratizes access to data and analytics tools to enable game developers to improve their games, increase revenue of their intellectual property, and optimize system performance by providing a fully integrated analytics solution. To provide a consistent, standardized set of data related to user input, game events, monetization, the system 100 identifies a core set of events which are tracked for any game. The events and related properties are automatically integrated in games created within the system 100 both on a game agnostic and genre-specific basis.

The user interfaces described above in FIGS. 4-6 allow for access to the data collected by the integrated analytics offering that will be offered to game developers as a companion service. This interface allows for both visualization of the standard analytics data along with custom event data specified by the game developer.

For any game created with the disclosed engine a core set of data is tagged automatically without need for user input. This data includes events that are common to all game/application deployments (e.g. application launches, crashes, exits, geographic and system information, user input) along with game or genre-specific events (e.g. level complete times, player health, in-app purchases). This data may be stored to the telemetry database 160.

The system 100 tags all games with a base set of event data regardless of the game type being created. Users of the engine will also be prompted to specify a game genre (e.g. 2D puzzle, 3D first person shooter) whose analytics properties have been templated and are added to the event system available for the game being developed. Events to be tracked included, but are not limited to: Player ID, Timestamp, Level/Zone Name, Level/Zone Time (enter/exit), Player Position, Location (Geo), Device, Platform/OS, Version, System Errors, Performance Info, Object/Trigger, Inventory, Equipped Item, CustomEvent$start, and CustomEvent$end.

The full set of analytical data can be accessed both through the developer clients 112. The visualization types that have been identified to view the data include: segmentation queries, funnel analysis, retention (cohort) analysis, and calculations.

In another embodiment, the system 100 can record the detailed play trace (player position, player camera view, user input, environmental variables, etc.) for each play through the game and provide the ability to save that place trace data for use in issue tracking. The system 100 allows for both recording of the issue within the disclosed system and/or saving out to external issue tracking systems (e.g. JIRA, Trac) through an available API. The data saved by the system 100 (stored either locally or externally) can be loaded back into the runtime version of the game and reproduce the issue exactly as experienced by the original user who logged the issue. The ability to both log issues without the necessity to write up detailed steps to reproduce and quickly visualize the issue by other members on the team within the runtime version of the game greatly reduces the time and effort on behalf of QA teams, both increasing efficiency and reducing cost.

In another embodiment, the system 100 provides a method for visualizing gameplay events in full three dimensional context within the game editor. All gameplay events, both predefined and custom, may be reported to an external metrics database. These events are grouped together by player session and event type, and include both the time and location of the event. Once data has been collected, it becomes available to the editor application at the developer client 112. The editor automatically filters data sets by type and zone, allowing the developer to choose an initial set of data to visualize. The developer may further filter this data in other ways, e.g. by time range or individual play session. These data points are then rendered as colored objects in the editor scene. Clusters of data points alter the color as density increases, allowing the user to quickly identify areas of high and low event concentration. Because the data is rendered in full three dimensional context inside the editor, the developer is then free to view the data from any angle or zoom necessary. This also means that the data is available in context of the scene's geometry and any other current visualizations, and that the developer may continue to work with the visualization enabled. This allows the developers to work directly in response to the data being rendered.

This contextualization of the data eliminates barriers between the information and the developer who needs to react to it. It presents the information in as unbiased a way as possible while providing the ability to refine and filter which data points are being displayed, which allows the user to understand and respond to the data with reduced training requirements.

### Computing Machine Architecture

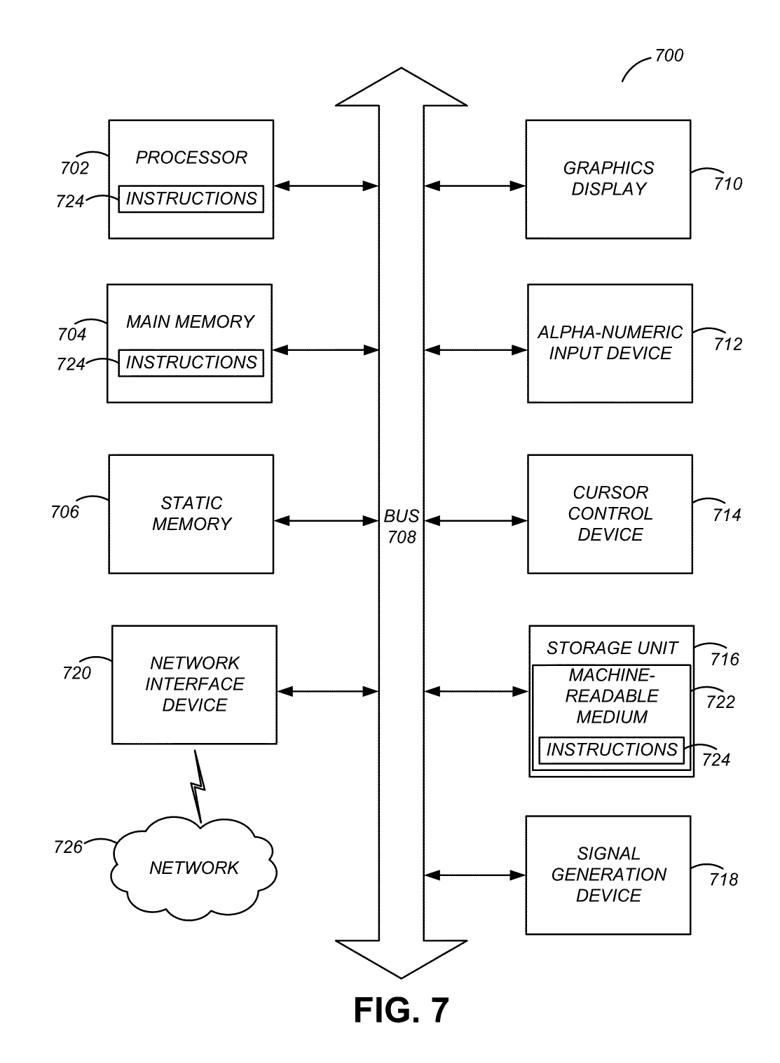

FIG. 7 is a block diagram illustrating components of an example machine (e.g., a computer) able to read instructions from a non-transitory machine-readable storage medium and execute them in a processor (or controller). The depicted machine or variations thereof may be used as the developer client 112, the master services server 130, or other computing devices described herein. Specifically, FIG. 7 shows a diagrammatic representation of a machine in the example form of a computer system 700 within which instructions 724 (e.g., software) for causing the machine to perform any one or more of the methodologies discussed herein may be executed. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions 724 (sequential or otherwise) that specify actions to be taken by that machine. Further, while only a single machine is illustrated, the term “machine” shall also be taken to include any collection of machines that individually or jointly execute instructions 724 to perform any one or more of the methodologies discussed herein.

The example computer system 700 includes a processor 702 (e.g., a central processing unit (CPU), a graphics processing unit (GPU), a digital signal processor (DSP), one or more application specific integrated circuits (ASICs), one or more radio-frequency integrated circuits (RFICs), or any combination of these), a main memory 704, and a static memory 706, which are configured to communicate with each other via a bus 708. The computer system 700 may further include graphics display unit 710 (e.g., a plasma display panel (PDP), a liquid crystal display (LCD), a projector, or a cathode ray tube (CRT)). The computer system 700 may also include alphanumeric input device 712 (e.g., a keyboard), a cursor control device 714 (e.g., a mouse, a trackball, a joystick, a motion sensor, or other pointing instrument), a storage unit 716, a signal generation device 718 (e.g., a speaker), and a network interface device 720, which also are configured to communicate via the bus 708.

The storage unit 716 includes a machine-readable medium 722 on which is stored instructions 724 (e.g., software) embodying any one or more of the methodologies or functions described herein. The instructions 724 (e.g., software) may also reside, completely or at least partially, within the main memory 704 or within the processor 702 (e.g., within a processor's cache memory) during execution thereof by the computer system 700, the main memory 704 and the processor 702 also constituting machine-readable media. The instructions 724 (e.g., software) may be transmitted or received over a network 726 via the network interface device 720.

While machine-readable medium 722 is shown in an example embodiment to be a single medium, the term “machine-readable medium” should be taken to include a single medium or multiple media (e.g., a centralized or distributed database, or associated caches and servers) able to store instructions (e.g., instructions 724). The term “machine-readable medium” shall also be taken to include any medium that is capable of storing instructions (e.g., instructions 724) for execution by the machine and that cause the machine to perform any one or more of the methodologies disclosed herein. The term “machine-readable medium” includes, but not be limited to, data repositories in the form of solid-state memories, optical media, and magnetic media.

### Additional Configuration Considerations

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

The various operations of example methods described herein may be performed, at least partially, by one or more processors, e.g., processor 702, that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for the described embodiments through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the scope defined in the appended claims.

What is claimed is:

1. A computer-implemented method for managing changes to digital gaming assets in a collaborative electronic game development environment including multiple remote developer clients, the method comprising:
storing to a local database, an indication of a change to a digital gaming asset made by a local developer client device executing a game editor;
determining if a duplicate of the digital gaming asset exists in the local database;
responsive to determining that the duplicate of the digital gaming asset does not exist in the local database, determining if a duplicate of the digital gaming asset exists in a master database at a master server, the master database server at a central location remote from the local database and the local developer client;
responsive to determining that the duplicate of the digital gaming asset exists in at least one of the local database and the master database, logging the change to the digital gaming asset in a local database change log;
responsive to determining that that the duplicate of the digital gaming asset does not exist in either the local database or the master database, importing the digital gaming asset to the local database in a compressed form and logging importation of the digital gaming asset in the local database change log;
synchronizing the local database to the master database to update the master database based on the local database change log;
synchronizing the local database from the master database to update the local database with changes in the master database corresponding to changes made at other remote developer clients;
requesting at the local developer client, a report characterizing game development status based on contents of the master database; and
providing the report to the local developer client.

2. The computer-implemented method of claim 1, further comprising:
responsive to determining that the duplicate of the digital gaming asset exists in at least one of the local database and the master database, generating an alias comprising a pointer to duplicate and storing the alias as an entry in the local database.

3. The computer-implemented method of claim 1, wherein synchronizing the local database to the master database occurs periodically according to a predefined time schedule.

4. The computer-implemented method of claim 1, wherein synchronizing the local database from the master database occurs periodically according to a predefined time schedule.

5. The computer-implemented method of claim 1, further comprising:
customizing the report based on a user profile associated with the local developer client.

6. A non-transitory computer-readable storage medium storing instructions for managing changes to digital gaming assets in a collaborative electronic game development environment including multiple remote developer clients, the instructions when executed by a processor causing the processor to perform steps including:
storing to a local database, an indication of a change to a digital gaming asset made by a local developer client device executing a game editor;
determining if a duplicate of the digital gaming asset exists in the local database;
responsive to determining that the duplicate of the digital gaming asset does not exist in the local database, determining if a duplicate of the digital gaming asset exists in a master database at a master server, the master database server at a central location remote from the local database and the local developer client;
responsive to determining that the duplicate of the digital gaming asset exists in at least one of the local database and the master database, logging the change to the digital gaming asset in a local database change log;
responsive to determining that that the duplicate of the digital gaming asset does not exist in either the local database or the master database, importing the digital gaming asset to the local database in a compressed form and logging importation of the digital gaming asset in the local database change log;
synchronizing the local database to the master database to update the master database based on the local database change log;
synchronizing the local database from the master database to update the local database with changes in the master database corresponding to changes made at other remote developer clients;
requesting at the local developer client, a report characterizing game development status based on contents of the master database; and
providing the report to the local developer client.

7. The non-transitory computer-readable storage medium of claim 6, further comprising:
responsive to determining that the duplicate of the digital gaming asset exists in at least one of the local database and the master database, generating an alias comprising a pointer to duplicate and storing the alias as an entry in the local database.

8. The non-transitory computer-readable storage medium of claim 6, wherein synchronizing the local database to the master database occurs periodically according to a predefined time schedule.

9. The non-transitory computer-readable storage medium of claim 6, wherein synchronizing the local database from the master database occurs periodically according to a predefined time schedule.

10. The non-transitory computer-readable storage medium of claim 6, further comprising:
customizing the report based on a user profile associated with the local developer client.

11. A method for generating analytical data representing changes in a collaborative electronic game development environment including multiple remote developers, the method comprising:
receiving from a plurality of different local databases, indications of changes made to digital assets in a digital game, each of the changes provided from a developer client devices executing a game editor;
updating a master database with the changes made at each of the plurality of local database servers;
generating a master change log logging changes to the master database;
aggregating the changes by assigning metadata tags to group a plurality of related changes;
generating a report characterizing the changes based on the metadata tags; and
providing the report to a requesting local developer client.

12. The method of claim 11, wherein the report indicates a sequence of changes made to the digital game, each of the sequence of changes indicating a developer that created the change.

13. The computer-implemented method of claim 11, further comprising:
customizing the report based on a user profile associated with the local developer client.
